(19) United States
(12) Patent Application Publication
(10) Pub. No.: US 2014/0255665 A1
(43) Pub. Date: Sep. 11, 2014

(54) CERAMIC MATRIX COMPOSITE COMPONENT FORMING METHOD

(71) Applicant: ROLLS-ROYCE PLC, London (GB)

(72) Inventors: Steven HILLIER, Manchester (GB); Owen Thomas DRAPER, Nottingham (GB); Anthony Gordon RAZZELL, Derby (GB); Dennis JONG, Delft (NL)

(21) Appl. No.: 14/196,489

(22) Filed: Mar. 4, 2014

(30) Foreign Application Priority Data
Mar. 6, 2013 (GB) 1303994.6

(51) Int. Cl. F01D 25/00; B29C 70/68

(52) U.S. Cl. CPC F01D 25/005; B29C 70/68
USPC 428/201; 427/372.2

(57) ABSTRACT

A method of forming a ceramic matrix composite component is provided. The method includes the steps of: providing a pattern element; coating the pattern element with a ceramic slurry; drying the slurry to form a ceramic layer; forming a ceramic matrix composite body on a surface of the ceramic layer to produce a ceramic matrix composite component with the ceramic layer attached thereto.

### FIELD OF THE INVENTION

The present invention relates to a method of forming a ceramic matrix composite component, such as a gas turbine engine component.

### BACKGROUND OF THE INVENTION

The performance of gas turbine engines, whether measured in terms of efficiency or specific output, is improved by increasing the turbine gas temperature. It is therefore desirable to operate the turbines at the highest possible temperatures. For any engine cycle compression ratio or bypass ratio, increasing the turbine entry gas temperature produces more specific thrust (e.g. engine thrust per unit of air mass flow). However, as turbine entry temperatures increase, it is necessary to develop components and materials better able to withstand the increased temperatures.

This has led, for example, to the replacement of metallic shroud segments with ceramic matrix composite shroud segments having higher temperature capabilities. To accommodate the change in material, however, adaptations to the segments have been proposed. For example, EP 0751104 discloses a ceramic segment having an aluminium phosphate-based abradable seal coating which is suitable for use with nickel base turbine blades, and EP 1965030 discloses a hollow section ceramic seal segment.

Whereas metallic materials allow operational temperatures up to 1150° C., some ceramic matrix composites are able to operate up to 1350° C. However, current turbine temperatures are around 1300-1400° C. and an aim is to increase these further. Accordingly, even ceramic matrix composites may need thermal protection. One option is to apply a thermal barrier coating to the composite based, for example, on the type of coating system described in EP 0751104.

Such coatings can be cast onto the ceramic matrix composite component. However, during drying and firing shrinkage may occur causing strain at the interfacial joint between materials, weakening the bond/mechanical strength/capability. Also the firing temperature of the coating must generally be lower than that of the composite to prevent a loss of properties in the composite, which limits the options for structuring the coating or can lead to undesirable further sintering of the coating in the engine. Such uncontrolled sintering may result in reactions with or inclusion of undesirable elements. Alternatively, the coating can be sintered and then adhered to the component using ceramic cement, but this can result in a relatively weak interfacial bond.

### SUMMARY OF THE INVENTION

It would be desirable to provide an alternative method for coating a ceramic matrix composite component.

Accordingly, in a first aspect, the present invention provides a method of forming a ceramic matrix composite component, the method including the steps of:
providing a pattern element;
coating the pattern element with a ceramic slurry;
drying the slurry to form a ceramic layer; forming a ceramic matrix composite body on a surface of the ceramic layer to produce a ceramic matrix composite component with the ceramic layer attached thereto.

Advantageously, forming the ceramic layer (which may serve as a thermal barrier or abradable coating) before the ceramic matrix composite body, allows the layer to be fired at a higher temperature than the forming temperature of the composite body and can help to prevent undesirable further sintering of the layer in use (e.g. in an engine).

In a second aspect, the present invention provides a component formed by the method of the first aspect.

Optional features of the invention will now be set out. Unless indicated otherwise, these are applicable singly or in any combination with any aspect of the invention.

The step of forming the ceramic matrix composite body may be performed by: forming a green ceramic matrix composite body on a surface of the ceramic layer; and sintering the green body to produce a ceramic matrix composite component with the ceramic layer attached thereto. During the sintering, pressure may be applied to force the ceramic layer and the green body together. The sintering may be performed in a vacuum or reduced pressure. The forming of the green body may include the sub-steps of: stacking successive plys of continuous fibre reinforcement on the surface of the ceramic layer, each stacked ply being covered in a slurry containing binder and ceramic; and processing (e.g. pressing and/or heating) the stacked and slurry-covered plys such that the stacked plys are embedded in a green ceramic matrix. The sintering of the green body then fuses the green ceramic matrix.

However, other techniques for forming the ceramic matrix composite body include, for example, chemical vapour infiltration or melt infiltration of a ceramic matrix material into a lay-up of ceramic reinforcement fibres situated on the surface of the ceramic layer.

The method may include a further step of removing the pattern element from the ceramic layer. For example, the removing step may be performed between the drying step and the forming step. However, the removing step may be performed as a final step, after the ceramic matrix composite component is produced with the ceramic layer attached thereto.

The method may include a step of sintering the ceramic layer, e.g. before the forming step. If the pattern element is removed between the drying step and the forming step, then the separate sintering step may be performed after the removal.

Alternatively, however, the ceramic layer may be sintered simultaneously with the step of forming of the ceramic matrix composite body, e.g. if the forming step is performed by forming a green ceramic matrix composite body and then sintering the green body, then the ceramic layer may be sintered simultaneously with the sintering of the green body. In this case, the removing step can be performed e.g. between the forming of the green body and the sintering of the green body.

The ceramic matrix composite component with the attached ceramic layer may be subsequently processed, e.g. by machining. For example, attachment formations and/or an improved surface finish can be provided.

The surface of the ceramic layer may be processed, e.g. by machining, before the ceramic matrix composite body is formed thereon. For example, it may be roughened or otherwise configured by mechanical keying and/or increased surface area to improve the bond strength to the body. Additionally or alternatively such surface features may be moulded in as part of the coating step.

The pattern element may be sacrificial. For example it may be a wax element. Wax pattern elements are conventionally used in investment casting procedures, for example for the production of turbine blades. They are highly flexible in terms of the final shapes that can be produced based on such pattern elements. Removal or “dewaxing” of the pattern element is also then straightforward to perform.

The slurry may be de-gassed before the coating step. This can reduce the amount of incumbent or entrapped air which can reduce bond strengths and structural properties.

The coating step can include building up successive layers of ceramic slurry on the pattern element. For example, the ceramic slurry may include silicate, alumina, mullite and/or zirconia. Each layer of the slurry may be modified to suit its requirements, e.g. by changing the shape, size or phase of the slurry particles or by incorporating particulates as discussed below.

The coating step can include incorporating particulates in the slurry, and thereby in the ceramic layer. For example, the particulates may be ceramic hollow particles, ceramic solid particles, ceramic whiskers, ceramic discontinuous fibres and/or ceramic platelets. The particulates can be pre-mixed in the slurry and applied to the pattern element therewith. Another option is for, the coating step to include building up successive and alternate layers of slurry and particulate.

The particulates can be incorporated at specific locations, for example at the surface of the ceramic layer on which the green ceramic matrix composite body is formed. By incorporating particulates at this surface, features can be introduced to key the layer to the composite body. Particles, e.g. providing enhanced abradability, may be provided at the opposite surface of the ceramic layer (i.e. adjacent the pattern element).

The coating step can include embedding hollow or sacrificial members in the ceramic slurry and/or locating hollow or sacrificial members at the surface of the ceramic slurry, the hollow or sacrificial members forming cooling channels in the ceramic layer and/or at the surface on which the ceramic matrix composite body is formed. For example, sacrificial members can be formed of wax or polymer and can be burnt or melted out during sintering to form the cooling channels. The channels may typically have a diameter in the range from 0.05 to 1 mm. In use, cooling air can flow through the channels to cool the component.

The method may include the further step of applying a ceramic cement to the surface of the ceramic layer before the step of forming the ceramic matrix composite body on the surface.

The component may be a gas turbine engine component. For example, the component may be a combustion tile, a seal segment for a shroud ring of a rotor, a flame holder, a jet pipe liner, a nozzle petal, a nozzle guide vane or a turbine blade. If the forming step is performed by forming a green ceramic matrix composite body and then sintering the green body, the sintering of the green body can be performed in situ in the engine.

Further optional features of the invention are set out below.

### BRIEF DESCRIPTION OF THE DRAWINGS

Embodiments of the invention will now be described by way of example with reference to the accompanying drawings in which:

FIG. 1 shows a longitudinal sectional elevation through a ducted fan gas turbine engine;

FIG. 2 shows schematically a sectional elevation through a portion of the high pressure turbine of the engine of FIG. 1; and

FIG. 3 shows schematically a perspective view of a seal segment.

FIG. 4 shows a flow diagram describing the process required to produce the seal segment.

### DETAILED DESCRIPTION AND FURTHER OPTIONAL FEATURES OF THE INVENTION

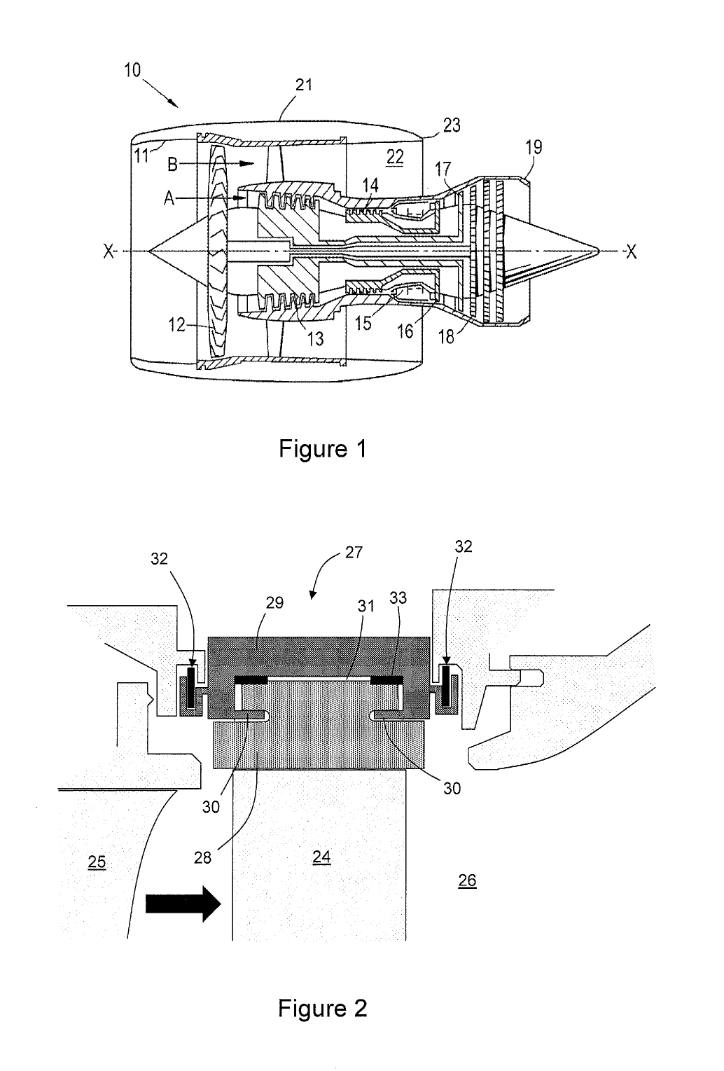

With reference to FIG. 1, a ducted fan gas turbine engine generally indicated at 10 has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, and intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

The gas turbine engine 10 works in a conventional manner so that air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

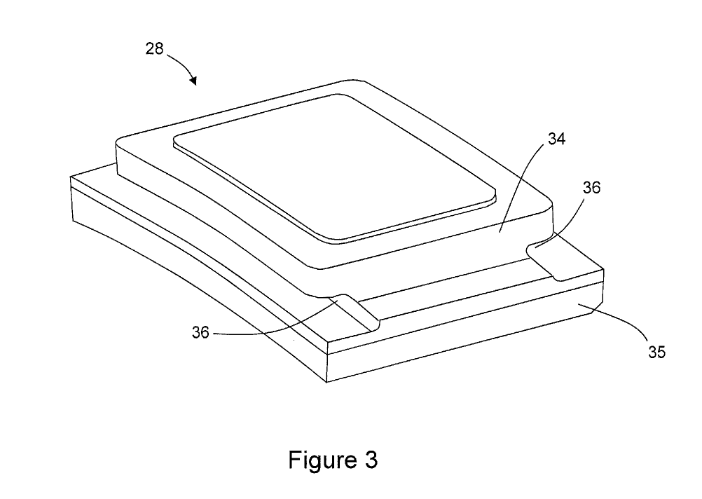

The high pressure turbine 16 includes an annular array of radially extending rotor aerofoil blades 24, the radially outer part of one of which can be seen if reference is now made to FIG. 2, which shows schematically a sectional elevation through a portion of the high pressure turbine. Hot turbine gases flow over nozzle guide vanes 25 and the aerofoil blades 24 in the direction generally indicated by the arrow. A shroud ring 27 in accordance with the present invention is positioned radially outwardly of the shroudless aerofoil blades 24. The shroud ring 27 serves to define the radially outer extent of a short length of the gas passage 26 through the high pressure turbine 16.

The turbine gases flowing over the radially inward facing surface of the shroud ring 27 are at extremely high temperatures. Consequently, at least that portion of the ring 27 must be constructed from a material which is capable of withstanding those temperatures whilst maintaining its structural integrity. Ceramic materials are particularly well suited to this sort of application.

The shroud ring 27 is formed from an annular array of seal segments 28 attached to a part of the engine casing which takes the form of an annular, metallic backing plate 29 having a central portion and radially inwardly projecting, front and rear flanges, with inwardly directed hooks 30 formed at the ends of the flanges. Cooling air for the ring 27 enters a space 31 formed between the backing plate 29, each segment 28 and a gasket-type sealing ring 33 located between the plate 29 and the segment 28, the air being continuously replenished as it leaks, under a pressure gradient, into the working gas annulus through suitable holes (not shown) in the backing plate 29. The backing plate 29 is sealed at its front and rear sides to adjacent parts of the engine casing by piston ring-type sealing formations 32 of conventional design.

FIG. 3 shows schematically a perspective view of one of the seal segments 28. The segment 28 has a lightly curved, plate-like, rectangular shape. A radially outer, body portion 34 of the segment 28 is formed from continuous fibre reinforced ceramic matrix composite, as discussed in more detail below. A thermal barrier coating 35 is formed on the radially inward facing surface of the body portion 34. The gasket-type sealing ring 33 (not shown in FIG. 3) runs around the edges of the radially outer surface of the body portion 34.

Respective birdmouth slots 36 extend in the circumferential direction along the front and rear sides of the body portion 34. To mount the seal segment 28 to the backing plate 29, the plate is split into two or more arc sections allowing the segments to be loaded thereon by circumferential sliding. The arc sections are then joined together to form the backing plate.

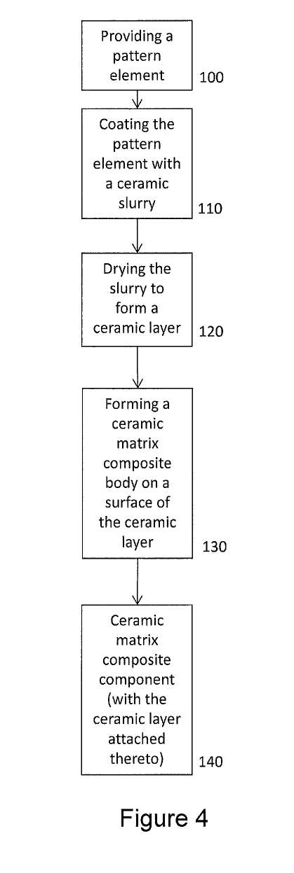

As shown in FIG. 4, to produce 140 the seal segment 28, a sacrificial wax pattern is produced having a pattern surface that corresponds to the shape of the gas-washed surface of the seal segment 100. The pattern is dipped or otherwise coated in a ceramic slurry containing e.g. silicate, alumina, mullite and/or zirconia 110 and allowed to dry. The dipping 110 and drying process 120 is continued until a desired thickness of slurry is built up. The slurry is preferably de-gassed prior to dipping. During the build-up, additional particulate media can be added to the layer, such as hollow or solid ceramic particles, ceramic whiskers, ceramic discontinuous fibres and/or ceramic platelets. Hollow members can also be embedded in the slurry and/or located at the surface of the slurry to act as cooling channels in the seal segment. Similarly, sacrificial wax or polymer members can be embedded in the slurry and/or located at this surface, and can subsequently be burnt or melted out to form the cooling channels. The procedure is thus similar to that used in investment casting to produce a ceramic mould.

Dewaxing is then performed by heating the coated pattern, which allows the wax to melt away and/or vaporise, to leave a self-supporting ceramic layer corresponding to the coating 35 that is fired to remove all liquid components and sinter the ceramic in the slurry. Alternatively, the firing can be postponed to be performed simultaneously with the firing that produces the ceramic matrix composite body portion 34 of the seal segment 28.

The optional particulate media added to the ceramic layer can be used to: enhance the keying of the coating 35 to the body portion 34, tailor the coefficient of thermal expansion of the coating, control the abradability of the coating etc.

A green ceramic matrix composite body is formed on a surface of the ceramic layer 130 (typically the surface that has not been in contact with the wax pattern). To enhance bonding, a ceramic cement may be applied to the surface before the green body is formed thereon. More particularly, the green body can be produced by stacking successive plys formed from a cloth of woven continuous fibre reinforcement. Each ply is covered in a water-based slurry containing a binder and ceramic. The slurry can be applied after each ply is stacked, or the slurry can be pre-impregnated into the plys before stacking. The reinforcement fibres can be bunched together to form a tow, and for each ply the tows woven in to a cloth (or sheet). The stacked plys are pressed to remove excess slurry, and heated which allows the binder to produce the green body.

The green body with the ceramic layer is then fired in a furnace (or alternatively fired directly in an engine environment) to drive off residual moisture and sinter the ceramic particles to form the surrounding matrix of the ceramic matrix composite body portion 34 (and also to fire the ceramic layer if that has not already been done). For example, the green body may be heated initially slowly to 100° C. to drive off residual moisture then ramped up to over 1100° C. to sinter the solids in the matrix. Tooling may be removed after the initial slow heating and before the sintering. Varying the pressure and temperature of the processing can give different levels of densification and therefore can vary the resultant mechanical properties of the component. The sintering may be performed in a vacuum or reduced pressure. The matrix is also bonded to the fibres and contains a distribution of micro-cracks which open and close as the component is loaded. The material is generally notch insensitive, unlike a monolithic ceramic. The temperature capability of such a composite may be conservatively 1150° C. for continuous use, but can be taken over 1200° C. for short excursions.

Features such as the birdmouth slots 36 can be produced by subsequent machining.

By way of example, the reinforcement fibres can be Nextel720™ and/or Nextel6101™ alumina silicate fibres available from 3M or similar, the ceramic particles can be alumina particles or a mixture of alumina and silicate particles. These are examples of Ox/Ox ceramic matrix composite materials, which are suitable for green body and sintering procedure discussed above. Another option, however, is to form the ceramic matrix composite body from a SiC/SiC ceramic matrix composite material, having a silicon carbide based matrix and silicon carbide based reinforcement fibres. A SiC/SiC composite body can be manufactured by CVI (chemical vapour infiltration) and/or MI (melt infiltration) of SiC matrix material into a lay-up of SiC reinforcement fibres situated on a surface of the ceramic layer.

Advantageously, the shape capability of this process is only limited by the capability to shape the pattern. Thus, although described above in relation to a seal segment, other components that can potentially be made in the same fashion include: combustion tiles, flameholders, jet pipe liners, nozzle petals, nozzle guide vanes and turbine blades. Further, although wax is generally a convenient choice for the material of the pattern, other materials may be used. For example, rather than having a sacrificial pattern that burns or melts off, a reusable pattern may be used, e.g. formed of steel, aluminium, plastic or wood. A release agent may be used in conjunction with a reusable pattern. Additionally or alternatively, the pattern may remain attached to the ceramic layer during formation of the ceramic matrix composite body 130. In this case, however, the pattern should preferably have a coefficient of thermal expansion that is matched to that of the coating, particularly if elevated temperatures are used to dry the slurry.

A further advantage of the process is that the ceramic layer can be fired at a higher temperature than the ceramic matrix composite. Conventionally, as described in EP 0751104, the layer would be cast onto the ceramic matrix composite so that the coating is fired at a lower temperature, or the coating would be formed separately and then cemented to the ceramic matrix composite which can result in a weak interfacial bond.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A method of forming a ceramic matrix composite component, the method including the steps of:
providing a pattern element;
coating the pattern element with a ceramic slurry;
drying the slurry to form a ceramic layer;
forming a ceramic matrix composite body on a surface of the ceramic layer to produce a ceramic matrix composite component with the ceramic layer attached thereto.

2. A method according to claim 1, wherein the step of forming the ceramic matrix composite body is performed by: forming a green ceramic matrix composite body on a surface of the ceramic layer; and sintering the green body to produce a ceramic matrix composite component with the ceramic layer attached thereto.

3. A method according to claim 2, wherein the forming of the green ceramic matrix composite body includes the sub-steps of:
stacking successive plys of continuous fibre reinforcement on the surface of the ceramic layer, each stacked ply being covered in a slurry containing binder and ceramic; and
processing the stacked and slurry-covered plys such that the stacked plys are embedded in a green ceramic matrix.

4. A method according to claim 1, including a step of sintering the ceramic layer before the forming step.

5. A method according to claim 2, wherein the ceramic layer is sintered simultaneously with the sintering of the green body.

6. A method according to claim 1, including a further step of removing the pattern element from the ceramic layer

7. A method according to claim 1, wherein the pattern element is a sacrificial pattern element.

8. A method according to claim 1, wherein the coating step includes building up successive layers of ceramic slurry on the pattern element.

9. A method according to claim 1, wherein the coating step includes incorporating particulates in the slurry, and thereby in the ceramic layer.

10. A method according to claim 1, wherein the coating step includes embedding hollow or sacrificial members in the ceramic slurry and/or locating hollow or sacrificial members at the surface of the ceramic slurry, the hollow members or sacrificial forming cooling channels in the ceramic layer and/or at the surface on which the ceramic matrix composite body is formed.

11. A method according to claim 1, including a further step of applying a ceramic cement to the surface of the ceramic layer before the step of forming the ceramic matrix composite body thereon.

12. A method according to claim 1, wherein the component is a gas turbine engine component.

13. A method according to claim 2, wherein the sintering of the green body is performed in situ in a gas turbine engine.

14. A component formed by the method according to claim 1.
